(19) United States
(12) Patent Application Publication
(10) Pub. No.: US 2016/0066535 A1
(43) Pub. Date: Mar. 10, 2016

(54) Expandable Animal Crate

(71) Applicant: Gabriele Anderson, Green Cove Springs, FL (US)

(72) Inventor: Gabriele Anderson, Green Cove Springs, FL (US)

(21) Appl. No.: 14/847,660

(22) Filed: Sep. 8, 2015

Related U.S. Application Data
(60) Provisional application No. 62/047,722, filed on Sep. 9, 2014.

(51) Int. Cl. A01K 1/02; A01K 1/00

(52) U.S. Cl. CPC A01K 1/0245; A01K 1/0035

(57) ABSTRACT

An expandable animal crate that expands and retracts in order to receive various sized animals therein. The expandable animal crate includes a first enclosing member adjustably disposed within a second enclosing member, wherein each enclosing member includes a base, one or more sidewalls, an open sidewall, and a top wall. The first enclosing member can be slid from the second enclosing member, thereby allowing the animal crate to be expanded as needed. A sliding mechanism having one or more tracks disposed on the first enclosing member engages one or more rollers disposed on the second enclosing member in order to allow the crate to easily expand and retract. The animal crate further includes a plurality of casters disposed on the base of the crate and a plurality of handles disposed on the sidewalls thereof, which can be utilized to make the crate easier to transport.

### CROSS REFERENCE TO RELATED APPLICATION

This application claims the benefit of U.S. Provisional Application No. 62/047,722 filed on Sep. 9, 2014. The above identified patent application is herein incorporated by reference in its entirety to provide continuity of disclosure.

### BACKGROUND OF THE INVENTION

1. Field of the Invention

The present invention relates to crate devices. More specifically, the present invention provides an expandable animal crate comprising a plurality of enclosing members, wherein a first enclosing member is adjustably disposed within a second enclosing member via a sliding mechanism. The animal crate further comprises a plurality of casters and handles disposed thereon in order to allow for convenient transport thereof.

Animal owners have to purchase differently sized cages and crates in order to accommodate their animal as it grows larger. Purchasing additional cages or crates can be expensive, and the user is often unable to reuse the smaller crates. As a result, a pet owner may accumulate several animal crates which may be difficult or inconvenient to store. Additionally, large animal crates cannot be adjusted in size and are thus difficult to store due to the substantial amount of space that the crate consumes. Further, if an individual obtains an additional animal or is taking care of another's pet, the individual must use a second cage or crate in order to accommodate the new animal. Therefore, there is a need in the prior art for an expandable animal crate or cage that can be increased in size as necessary to accommodate a growing animal or an additional animal.

It is submitted that the present invention substantially diverges in design elements from the prior art and consequently it is clear that there is a need in the art for an improvement to existing expandable animal crates. In this regard the instant invention substantially fulfills these needs.

### SUMMARY OF THE INVENTION

The present invention provides a new expandable animal crate wherein the same can be utilized for providing convenience for the user when caring for a growing animal or more than one animals.

It is therefore an object of the present invention to provide a new and improved expandable animal crate device that has all of the advantages of the prior art and none of the disadvantages.

It is another object of the present invention to provide an expandable animal crate comprising a plurality of enclosing members, wherein a first enclosing member is adjustably disposed within a second enclosing member via a sliding mechanism.

Another object of the present invention is to provide an expandable animal crate wherein the sliding mechanism comprises one or more tracks disposed on the upper surface of the top wall of the first enclosing member and one or more rollers disposed on the underside of the second enclosing member, wherein the tracks and rollers engage one another.

Yet another object of the present invention is to provide an expandable animal crate further comprising a plurality of apertures disposed on the first and second enclosing member, wherein the apertures of the first enclosing member are adapted to align with the apertures of the second enclosing member so a fastener can be disposed through a pair of aligned apertures in order to allow the enclosing members to lock in a fixed position relative to one another.

Yet another object of the present invention is to provide an expandable animal crate further comprising a plurality of casters disposed on the base of the crate and a plurality of handles disposed on the sidewalls thereof, which can be utilized to carry the crate.

Yet another object of the present invention is to provide an expandable animal crate wherein, in alternate embodiments of the enclosing members, the first and second enclosing members each comprise one or more sidewalls hingedly or removably secured to a base and top wall so as to allow the enclosing members to fold in a compact configuration for storing.

Another object of the present invention is to provide an expandable animal crate that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the expandable animal crate.

FIG. 2 shows a close-up view of the sliding mechanism of the expandable animal crate.

FIG. 3 shows a side perspective view of the expandable animal crate device wherein the crate is disposed in a retracted configuration.

FIG. 4 shows a perspective view of the second enclosing member of the expandable animal crate wherein the enclosing member is positioned for folding.

### DETAILED DESCRIPTION OF THE INVENTION

Reference is made herein to the attached drawings. Like reference numerals are used throughout the drawings to depict like or similar elements of the expandable animal crate. For the purposes of presenting a brief and clear description of the present invention, the preferred embodiment will be discussed as used for caring for a growing animal or more than one animals. The figures are intended for representative purposes only and should not be considered to be limiting in any respect.

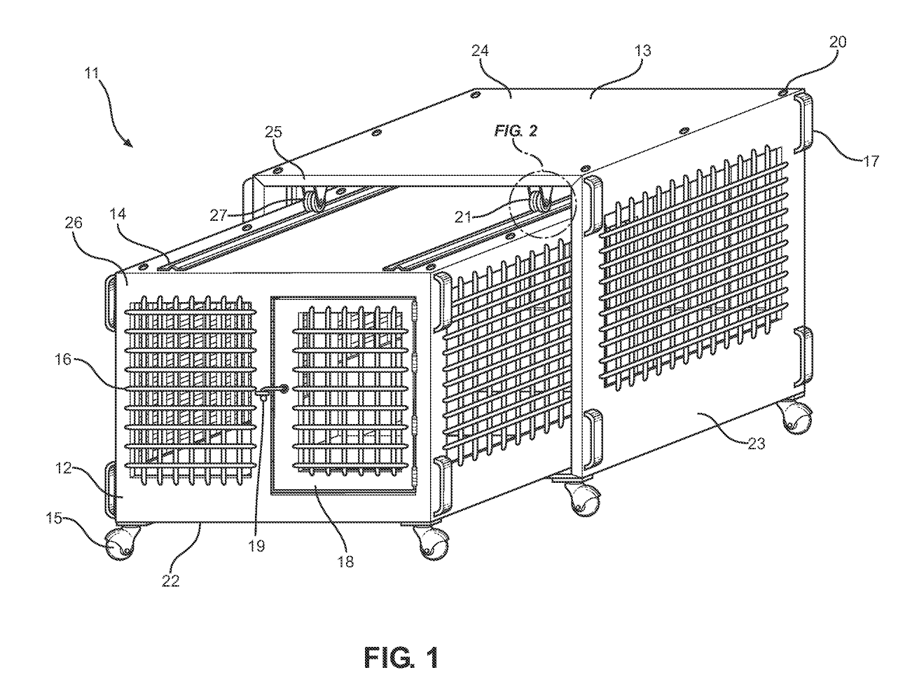

Referring now to FIG. 1, there is shown a perspective view of an embodiment of the expandable animal crate. The expandable animal crate 11 is adapted to allow a user to house train an animal or provide a secure location for the animal to remain when unsupervised. The expandable animal crate 11 comprises a plurality of enclosing members, wherein a first enclosing member 12 is adjustably disposed within a second enclosing member 13. Each enclosing member 12, 13 comprises a base 22, one or more sidewalls 23, a top wall 24, and an open sidewall 25. The open sidewall 25 of the first enclosing member 12 is disposed through the open sidewall 25 of the second enclosing member 13 so as to define a unified interior volume of the expandable animal crate 11. The interior volume of the crate 11 is adapted to receive one or more animals therein. Preferably, one or more sidewalls 23 comprise a plurality of openings 16 disposed in a grid pattern so as to allow an animal contained therein to view therethrough and to receive adequate air flow.

In the illustrated embodiment, each enclosing member 12, 13 comprises a rectangular shape in order to conveniently and discreetly fit within a corner of a home. The dimension of the first enclosing member 12 is smaller than the second enclosing member 13 in order for the first enclosing member 12 to fit therein. In other embodiments, additional enclosing members may be slidably disposed between the first and second enclosing members 12, 13. The enclosing members disposed between the first and second enclosing members 12, 13 comprise open opposing sidewalls so as to allow one or more animals to fit or move between the first and second enclosing members 12, 13.

The expandable animal crate 11 further comprises one or more doors 18 disposed thereon in order to provide access to the interior volume thereof. In the illustrated embodiment, one or more doors 18 are disposed on the sidewalls 23 of the enclosing members 12, 13. The doors 18 comprise a rectangular shape and are hingedly secured to the sidewall 23 along one edge thereof, whereas the opposing edge is removably secured to the sidewall 23 by a latch mechanism 19. This configuration of the hinge securement and the latch mechanism 19 disposed on opposing edges of the door 18 allows for the door 18 to remain securely closed if an animal were to push outwards on the door 18 from the interior of the crate 11.

In some embodiments, a plurality of casters 15 are disposed on the underside of the base 22 of the enclosing members 12, 13. In the illustrated embodiment, a pair of casters 15 are disposed on the corners of the front end 26 of the first enclosing member 12, whereas casters 15 are disposed on all four corners of the second enclosing member 13. Thus, the rear end of the first enclosing member 12 can slide in and out of the second enclosing member 13 without the obstruction of casters 15. The casters 15 allow a user to conveniently and easily roll the animal crate 11 along a surface in order to reposition or transport the crate 11 from one location to another. In some embodiments, the casters 15 are removable so as to allow the crate 11 to remain in an immobile position.

Furthermore, one or more handles 17 are disposed on the exterior of the expandable animal crate 11 in order to provide a user with a place to grasp when carrying the crate 11 or sliding the enclosing members 12, 13 closer to or further apart from one another. In the illustrated embodiment, the handles 17 are vertically positioned along the sidewalls 23 of the first and second enclosing members 12, 13. However, in alternate embodiments, the handles 17 can be disposed in any suitable position as long as the first enclosing member 12 is able to slide within the second enclosing member 13 in an unobstructed manner.

The expandable animal crate 11 further comprises a sliding mechanism 27 that allows the first enclosing member 12 to slide within the second enclosing member 13. The sliding mechanism 27 allows the inner enclosing member to linearly align with the outer enclosing member so as to conveniently expand or retract the crate 11. The sliding mechanism 27 comprises one or more tracks 14 disposed on the inner enclosing member that engage with one or more rollers 15 on the outer enclosing member. In the illustrated embodiment, the tracks 14 are on the top wall 24 of the first enclosing member 12, but in other embodiments, the tracks 14 are located on various portions of the enclosing member 12. The sliding mechanism 27 further comprises one or more rollers 15 disposed on the underside of the top wall 24 of the second enclosing member 13, wherein a roller 15 engages a track 14 so as to rotate therealong in a linear manner. In alternate embodiments, the rollers are located on various portions of the enclosing member 13 so as to engage with the tracks 14.

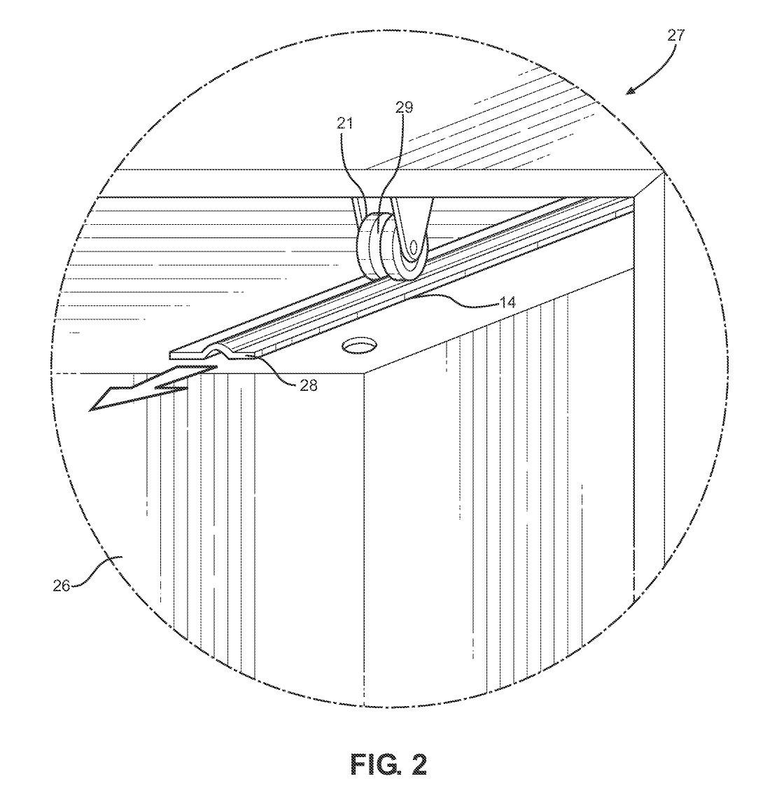

Referring now to FIG. 2, there is shown a close-up view of the sliding mechanism of the expandable animal crate. Each track 14 comprises a protrusion 28 extending the length thereof, whereas each roller comprises an indentation 29. The indentation 29 receives the protrusion 28 therein as the roller 21 rotates along the track 14 so that the roller remains in position on the track and does not become displaced therefrom. In alternate embodiments, the track 14 and roller 21 can comprise any suitable configuration that enables the roller 21 to rotate along the track 14. For example, a track 14 can comprise a channel extending along the length thereof, whereas the roller 21 is adapted to fit within the channel so as to rotate therealong. In some embodiments, the end of the track 14 disposed within the second enclosing member 13 comprises a stopper so as to prevent the first enclosing member 12 from separating from the second enclosing member 13. Any suitable stopper may be used, such as a vertical section extending upwards from the track 14.

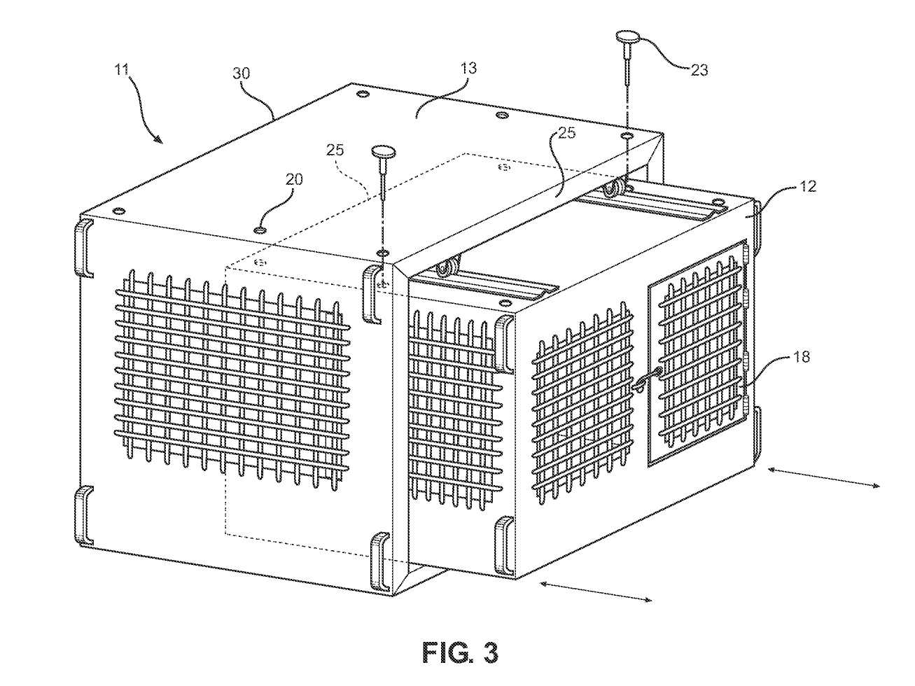

Referring now to FIG. 3, there is shown a side perspective view of the expandable animal crate device wherein the crate is disposed in a retracted configuration. The expandable animal crate 11 further includes a locking mechanism that allows the first enclosing member 12 to remain stationary relative to the second enclosing member 13 once the desired crate 11 size is achieved. In the illustrated embodiment, the locking mechanism comprises a plurality of apertures 20 disposed along the top walls 24 of the enclosing members 12, 13. The apertures 20 on the first enclosing member 12 are adapted to align with the apertures 20 on the second enclosing member 13, wherein a fastener 23 is disposed through the pair of aligned apertures 20. Thus, the enclosing members 12, 13 are locked in place and the crate 11 is unable to expand or retract until the fasteners 23 are removed. In some embodiments, a plurality of fasteners 23, such as spring loaded locking pins, are disposed through a pair of aligned apertures 20 in order to prevent the fasteners from being easily removed. The apertures 20 can be disposed anywhere along the enclosing members so long as they are adapted to align with one another and avoid obstructing the sliding ability thereof.

In operation, the first enclosing member 12 and second enclosing member 13 may be slid apart from one another until the crate 11 is disposed in an expanded configuration. The first enclosing member 12 may be slid into the second enclosing member 13 in order to form a retracted configuration. Thus, the expandable animal crate 11 can be expanded as necessary in order to accommodate multiple animals, provide more room to a growing animal, or simply provide more room to an animal for the animal's comfort. The retracted configuration allows the crate 11 to provide a secure, den-like space for a smaller animal or allow a user to position the crate 11 in a more compact configuration when unoccupied by an animal.

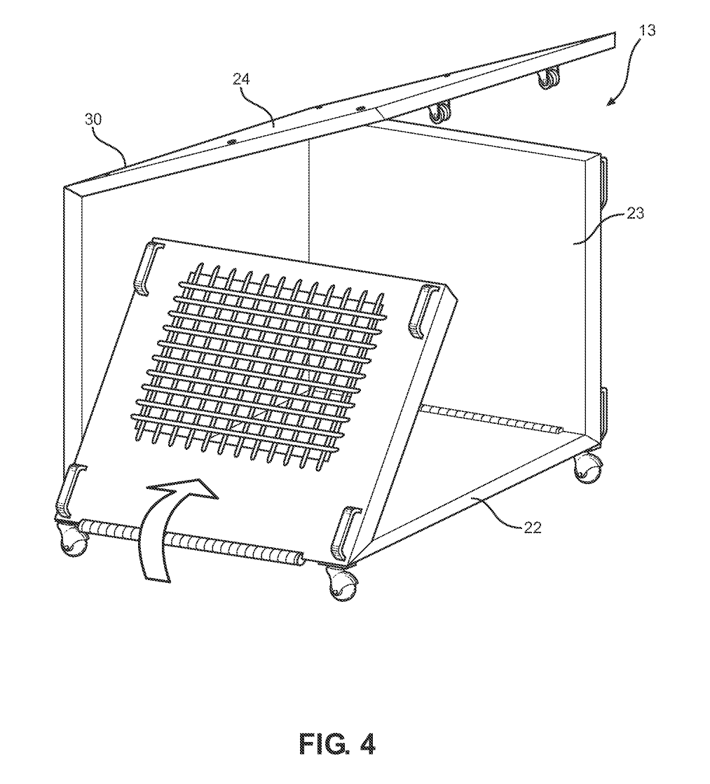

Referring now to FIG. 4, there is shown a perspective view of the second enclosing member of the expandable animal crate wherein the enclosing member is positioned for folding. In some embodiments, the connections between the top wall 24, base 22, and sidewalls 23 are removable from one another or hingedly attached so as to allow the expandable animal crate 11 to collapse or fold for storage. In the illustrated embodiment, the opposing sidewalls 23 of the enclosing member 13 are hingedly secured to the base 22 and removably secured to the top wall 24. The sidewall 23 disposed on the rear end 30 of the enclosing member 13 is hingedly secured to both the base 22 and top wall 24. Any suitable fastener can be used to removably secure the sidewalls 23 to the base 22 or top wall 24, such as hook and loop material, magnets, or interlocking joints. Thus, the walls 23, 24 and base 22 can be folded relative to one another and disposed in a compact configuration. In other embodiments, the edges of the base 22, sidewalls 24, and top wall 24 can be hingedly or removably secured to one another in any combination of ways such that the enclosing member 13 is able to collapse for storing.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An expandable animal crate, comprising:
a plurality of enclosing members, wherein a first enclosing member is adjustably disposed within a second enclosing member, wherein each of said first enclosing member and said second enclosing member comprise a base, one or more sidewalls, an open sidewall, and a top wall, defining an interior volume;
wherein said open sidewall of said first enclosing member is disposed through said open sidewall of said second enclosing member and within said interior volume of said second enclosing member;
a sliding mechanism disposed on said first enclosing member and said second enclosing member so as to allow an interior volume thereof to be adjusted as said first enclosing member slides within said second enclosing member.

2) The expandable animal crate of claim 1, further comprising a plurality of casters disposed on said base of said first enclosing member and said second enclosing member.

3) The expandable animal crate of claim 1, wherein said sliding mechanism comprises one or more tracks disposed on said first enclosing member and one or more rollers disposed on said second enclosing member such that said one or more rollers engage and align with said one or more tracks and are movable along said one or more tracks.

4) The expandable animal crate of claim 3, wherein each of said one or more tracks comprise a protrusion and each of said one or more rollers comprise an indentation, such that said protrusion is disposed within said indention and slidably engages therewith.

5) The expandable animal crate of claim 1, wherein said one or more sidewalls comprise a plurality of openings arranged in a grid pattern.

6) The expandable animal crate of claim 1, further comprising one or more doors disposed on said first enclosing member and said second enclosing member.

7) The expandable animal crate of claim 6, further comprising a latch mechanism disposed on each of said one or more doors in order to allow said one or more doors to remain in a closed configuration.

8) The expandable animal crate of claim 1, further comprising one or more handles disposed on each of said first enclosing member and said second enclosing member.

9) The expandable animal crate of claim 1, further comprising a locking mechanism for securing said first enclosing member in a fixed position relative to said second enclosing member.

10) The expandable animal crate of claim 9, wherein said locking mechanism comprises one or more apertures disposed on said first enclosing member and one or more apertures disposed on said second enclosing member such that each of said one or more apertures of said first enclosing member are adapted to align with each of said one or more apertures of said second enclosing member, wherein a pair of aligned apertures are adapted to receive a fastener therethrough.

11) The expandable animal crate of claim 1, wherein said one or more sidewalls are hingedly secured to said base and said top wall, wherein at least one of said one or more sidewalls is removably secured to said top wall such that said first enclosing member and said second enclosing member are collapsible into a compact configuration for storing.
